(19) United States
(12) Patent Application Publication
(10) Pub. No.: US 2015/0135844 A1
(43) Pub. Date: May 21, 2015

(54) Method for joining ceramic bodies by means of an active hard solder, or braze, assembly having at least two ceramic bodies joined with one another, especially a pressure measuring cell

(71) Applicant: Endress + Hauser GmbH + Co. KG, Maulburg (DE)

(72) Inventors: Nils Ponath, Lorrach (DE); Andreas Rossberg, Bad Sackingen (DE); Elke Schmidt, Bad Sackingen (DE)

(21) Appl. No.: 14/413,281

(22) PCT Filed: Jun. 7, 2013
(86) PCT No.: PCT/EP2013/061812

§ 371 Date: Jan. 7, 2015

(30) Foreign Application Priority Data
Jul. 11, 2012 (DE) 10 2012 013 663.3
Oct. 24, 2012 (DE) 10 2012 110 152.3

(51) Int. Cl. G01L 9/00; B23K 1/19; C04B 37/00; B23K 1/00

(52) U.S. Cl. CPC G01L 9/0075; B23K 1/0008; B23K 1/19; C04B 37/003
USPC 73/724; 403/272; 228/121

(57) ABSTRACT

An assembly, comprising two ceramic bodies, which are connected by means of a joint, which contains an active hard solder, or braze, wherein the active hard solder, or braze, has a continuous core volume, which is spaced from the ceramic bodies, in each case, by at least 1 μm, especially at least 2 μm, and wherein the joint has bounding layers, which border on the ceramic body. The the core volume, which includes at least 50% of the volume of the joint, is free of crystalline phases of size greater than 6 μm, especially greater than 4 μm, preferably greater than 2 μm.

The present invention relates to an assembly, which has at least two ceramic bodies joined with one another, especially a pressure measuring cell, as well, as to a method for joining ceramic bodies by means of an active hard solder, or braze.

Due to the special relevance of the invention for pressure measurement cells, the invention will be explained based on pressure measurement cells as an example of its application.

Pressure measurement cells according to the state of the art combine a ceramic measuring membrane and a ceramic platform, wherein the measuring membrane is connected pressure-tightly with the platform along a peripheral joint, which contains an active hard solder, or braze, wherein a pressure chamber is formed between the measuring membrane and the platform, wherein the equilibrium position of the measuring membrane results from the difference between a pressure reigning in the pressure chamber and a pressure acting on the outside surface of the measuring membrane facing, thus its surface facing away from the pressure chamber.

Serving as material for the platform and the measuring membrane are especially aluminum oxide ceramics, which, due to their elastic properties and their media resistance, are suited for the manufacture of pressure measurement cells. The mentioned ceramic components are especially joined with an active hard solder, or braze, which is preferably an active hard solder, or braze, containing Zr, Ni and Ti. The manufacture of such an active hard solder, or braze, is disclosed, for example, in European Offenlegungsschrift EP 0 490 807 A2. According to the method described there, especially rings of the active braze, material can be manufactured, which are positioned between measuring membrane and platform, in order to solder, or braze, these with one another.

For joining the components, for example, the ceramic bodies are heated with an intermediately lying, solder preform in high vacuum to a temperature, which melts the active hard solder, or braze, so that a reaction begins between the active hard solder, or braze, and the ceramic bodies. By cooling, the active hard solder, or braze, solidifies and the reaction between the active hard solder, or braze, and the ceramic body is stopped. During cooling, however, domains of various phases can crystallize out from the melt of the active hard solder, or braze, wherein the phases have different thermomechanical properties, for example, coefficients of expansion, so that considerable mechanical stress concentrations can occur in the structure at the grain boundaries between the different phases. This can, on the one hand, degrade the strength of the joint, and, on the other hand, lead to hysteresis in the measuring due to plastic deformation in the structure. This is remarkable, considering that the active hard solder, or braze, is, in general, present before the soldering as sufficiently homogeneous, namely amorphous, respectively fine crystalline, material, which is free of such problems.

It is, consequently, an object of the invention to provide an assembly and a pressure measuring cell, as well as a manufacturing process therefor, whereby the mentioned disadvantages of the state of the art are overcome.

The object is achieved according to the invention by the assembly as defined in independent claim 1, the pressure measuring cell as defined in independent claim 14 and the method as defined in independent claim 15.

An assembly of the invention includes a first ceramic body and a second ceramic body, wherein the first ceramic body and the second ceramic body are connected by means of a joint, wherein the joint contains an active hard solder, or braze, wherein the active hard solder, or braze, has a continuous core volume, which is spaced from the first ceramic body and the second ceramic body, in each case, by at least 1 μm, especially at least 2 μm, wherein the joint has a first bounding layer and a second bounding layer, which border on the first ceramic body, respectively the second ceramic body, wherein the core volume according to the invention includes at least 50% of the volume of the joint and is free of crystalline phases of size greater than 6 μm, especially greater than 4 μm, preferably greater than 2 μm.

In another concept, the assembly of the invention includes a first ceramic body and a second ceramic body, wherein the first ceramic body and the second ceramic body are connected by means of a joint, wherein the joint contains an active hard solder, or braze, wherein the active hard solder, or braze, averaged over a continuous core volume, which is spaced from the first ceramic body and from the second ceramic body, in each case, by at least 1 μm, especially at least 2 μm, has an average composition C_{K} having a liquidus temperature Tₗ(C_{K}), wherein C_{K}:=(C_{K1}, . . . , C_{KN}), wherein |C_{K}|=1, and wherein the C_{Ki} are the stoichiometric fractions of the components Kᵢ i=1, . . . , N of the average composition of the active hard solder, or braze, in the core volume, wherein the joint has a first bounding layer and a second bounding layer, which border on the first ceramic body, respectively on the second ceramic body, wherein according to the invention at least one of the bounding layers, which lies outside of the core volume, has an average composition C_{B} having a liquidus temperature Tₗ(C_{B}), which lies not less than 20 K, preferably not less than 40 K, and especially preferably not less than 80 K under the liquidus temperature Tₗ(C_{K}) of the average composition C_{K} of the core volume, wherein C_{B}:=(C_{B1}, . . . , C_{BN}), wherein |C_{B}|=1, and wherein the C_{Bi} are the stoichiometric fractions of the components Kᵢ i=1, . . . , N of the average composition of the active hard solder, or braze, in the bounding layer.

In a further development of the invention, the at least one bounding layer has a thickness of no more than 3 μm, especially no more than 2 μm and preferably no more than 1 μm.

In a further development of the invention, the joint is ring-shaped, wherein the core volume is defined by a body of revolution, which is formed by rotation of a convex polygon, especially a rectangle, about the principal axis of revolution of the ring.

In a further development of the invention, the liquidus temperature rises from Tₗ(C_{B}) to the liquidus temperature Tₗ(C_{K}) monotonically with change of composition from C_{B} to C_{K}.

In a further development of the invention, the composition C_{B} has a liquidus temperature Tₗ(C_{B}), which lies no more than 300 K, especially no more than 150 K, and preferably no more than 50 K above the liquidus temperature Tₗ(Cₑ) of the eutectic point, respectively the nearest intersection with a eutectic valley, having a composition Cₑ in the composition space, wherein Cₑ:=(cₑ₁, . . . , c_{eN}), wherein |Cₑ|=1, and wherein the cₑᵢ are the stoichiometric fractions of the components Kᵢ with i=1, . . . , N at the eutectic point, respectively a nearest intersection with a eutectic valley.

In a further development of the invention, the alloy of the joint has at the eutectic point, respectively at the nearest intersection with a eutectic valley in the composition space, a composition Cₑ, wherein Cₑ:=(cₑ₁, . . . , c_{eN}), wherein |Cₑ|=1, wherein the cₑᵢ are the stoichiometric fractions of the components Kᵢ with i=1, . . . , N at the eutectic point, respectively at the nearest intersection with a eutectic valley, wherein the difference between the composition Cₑ and the composition C_{B} is describable with a normalized vector difference D_{eB}, wherein:
Cₑ=C_{B}+a_{eB}*D_{eB}, with |D_{eB}|=1, wherein the difference between the composition C_{K} and the composition C_{B} is describable with a normalized vector difference D_{KB}, wherein: C_{K}=C_{B}+a_{KB}*D_{KB}, with |D_{KB}|=1, wherein a_{eB} and a_{KB} are positive scalars, wherein for the scalar product s_{eK}:=D_{eB}·D_{KB}: S_{eK}<0, especially s_{eK}<−0.5, preferably s_{eK}<−0.8.

In a further development of the invention, the composition C_{K} of the core volume contains metals, which also the composition C_{B} of the bounding layer contains.

In a further development of the invention, the first ceramic body and/or the second ceramic body comprise/comprises Al₂O₃.

In a further development of the invention, the active hard solder, or braze, comprises Zr, Ni and Ti.

In a further development of the invention, the composition C_{K} contains essentially zirconium and nickel, especially in a stoichiometric ratio of, for instance, 3 to 1, wherein the zirconium fraction amounts to, for example, 76 atom-% and the nickel fraction, for example, 24 atom-%.

In a further development of the invention, the bounding layer has a composition CB, which comprises, for instance, 42 to 52 atom-% Zr, 23 to 28 atom-% Ni and 24 to 30 atom-% Ti, especially 47 atom-% Zr, 26 atom-% Ni and 27 atom-% Ti, wherein, in given cases, Al diffuses in, wherein, in cases where Al is present, especially the titanium fraction is reduced from the above specifications for Ti.

In a further development of the invention, the two bounding layers of the joint have the composition C_{B}.

The pressure measuring cell of the invention includes an assembly of the invention, wherein the first ceramic body is a membrane body of a measuring membrane of the pressure measuring cell, wherein the second ceramic body is a platform of the pressure measuring cell, and wherein the platform and the measuring membrane are joined pressure-tightly with one another by means of the joint, which is ring-shaped.

The method of the invention for manufacturing a special assembly of the invention, which assembly comprises a first ceramic body and a second ceramic body, wherein the first ceramic body and the second ceramic body are joined by the method by means of an active hard solder, or braze, includes steps as follows:

providing of the active hard solder, or braze, between the ceramic bodies, wherein the active hard solder, or braze, has, averaged over a continuous core volume, an average composition C_{K0} having a liquidus temperature Tₗ(C_{K0}), wherein C_{K0}:=(c_{K01}, . . . , c_{K0N}), wherein |C_{K0}|=1, and wherein the c_{Ki} are the stoichiometric fractions of the components Kᵢ i=1, . . . , N of the average composition of the active hard solder, or braze, in the core volume, wherein the active hard solder, or braze, has, on at least one of its surfaces facing the ceramic bodies, a bounding layer having an average composition C_{B0}, wherein the composition C_{B0} has a liquidus temperature Tₗ(C_{B0}), which lies not less than 20 K, preferably not less than 40 K, and especially preferably not less than 80 K, under the liquidus temperature Tₗ(C_{K0}) of the average composition C_{K0} of the main volume,
wherein C_{B0}:=(c_{B01}, . . . , c_{B0N}, wherein |C_{B0}|=1, and wherein the c_{B0i} are the stoichiometric fractions of the components Kᵢ i=1, . . . , N of the average composition of the active hard solder, or braze, in the bounding layer; and
heating the ceramic bodies and the active hard solder, or braze, in a vacuum soldering, brazing process, up to melting of the composition C_{B0}, wherein the melt of the bounding layer mixes in the transition to the core volume with the material of the core volume, whereby the liquidus temperature of the bounding layer is increased, so that the bounding layer at least partially isothermally solidifies or becomes more viscous.

In a further development of the method, the providing of the active hard solder, or braze, includes that a solder preform, which has the composition C_{K0}, is coated by means of gas phase deposition, for example, by sputtering, at least on one surface, preferably on two oppositely lying surfaces, with a bounding layer, which has the composition C_{B0}.

In a further development of the method, the providing of the active hard solder, or braze, includes that at least one surface section of a ceramic body, especially two oppositely lying surface sections of the two ceramic bodies, is, respectively are, coated with a bounding layer, which has the composition C_{B0}, wherein the coating occurs, for example, by gas phase deposition, especially sputtering. In an embodiment of this further development of the method, there is arranged between the ceramic bodies provided with the bounding layer a solder preform, which has a core volume with the composition C_{K0}, and which, in given cases, is coated with a bounding layer of composition C_{B0}.

In a further development of the method, the composition C_{K0} comprises Zr and Ni in a stoichiometric ratio of 3 to 1, for example, 20 atom-% to 30 atom-% Ni and remainder Zr, especially, for instance, 22 atom-% to 26 atom-% Ni, preferably 24 atom-% Ni.

In a further development of the method, the composition C_{B0} comprises, for instance, 42 to 52 atom-% Zr, 23 to 28 atom-% Ni and 24 to 30 atom-% Ti, for example, 45 to 49 atom-% Zr, 24.5 to 27 atom-% Ni and 26 to 29.5 atom-% Ti, and preferably 47 atom-% Zr, 26 atom-% Ni and 27 atom-% Ti.

The invention will now be explained based on the example of an embodiment illustrated in the drawing, the figures of which show as follows:

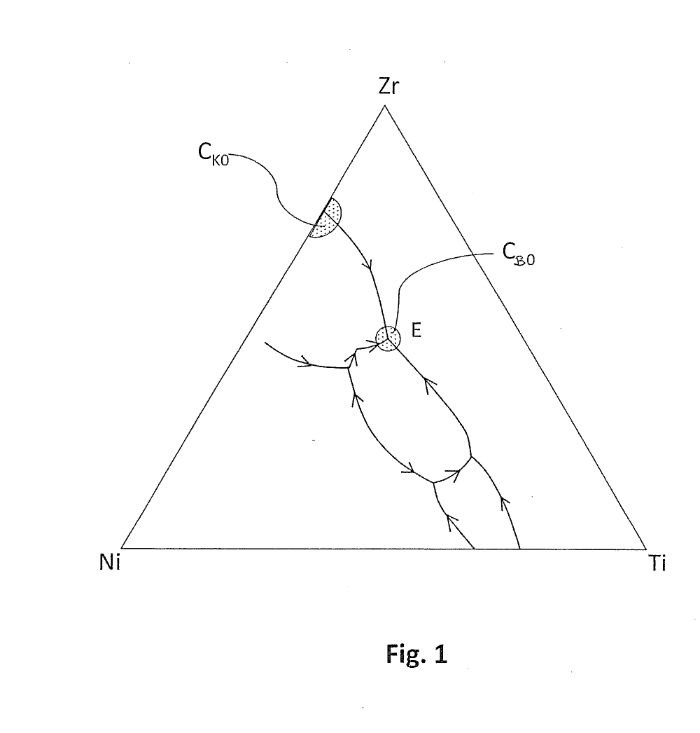

FIG. 1 A simplified diagram for the ternary system Ni—Ti—Zr (see Gupta, K. P.: The Ni—Ti—Zr system (nickel-titanium-zirconium). Journal of Phase Equilibria, 20(4):441-448, August 1999);

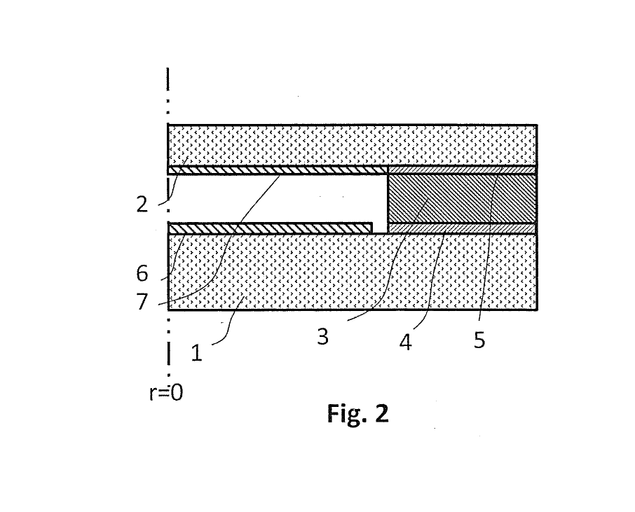

FIG. 2 a longitudinal section through a pressure measuring cell of the invention;

The diagram shown in FIG. 1 for the ternary Ni—Ti—Zr system is based on data of Gupta (Journal of Phase Equilibria, 20(4), pages 441-448, August 1999). It shows the position of the eutectic point E

and various eutectic valleys. The arrows in the eutectic valleys point toward lower liquidus temperature.

Proceeding from this data, according to the invention, a core volume of an active hard solder, or braze, is provided, which determines the mechanical properties of a joint formed therewith, having a composition C_{K0}, for example, as a solder preform, wherein the surfaces of the core volume are coated with a bounding layer of a composition C_{B0}, wherein the last named composition has a significantly lower melting point than the composition of the core volume.

Especially, the composition C_{B0} of the bounding layer can be selected to be at or near the eutectic point, such as indicated in FIG. 1. A suitable composition C_{B0} comprises, for example, 47 atom-% Zr, 26 atom-% Ni and 27 atom-% Ti. The associated liquidus temperature amounts, for instance, to 770° C.

The liquidus temperature of a composition of the core volume with 76 atom-% Zr and 24 atom-% Ni amounts, in contrast, to, for instance, 960° C.

Correspondingly, the bounding layer can be reliably melted at a soldering temperature of 800° C. to 850° C., for example, without melting the core volume of the active hard solder, or braze.

As a result, the fine crystalline, respectively amorphous, structure of the core volume can be retained in the soldering. Solely at the interface between the bounding layer and the core volume is there, in given cases, an exchange of materials between the core volume and the bounding layer, such that the bounding layer experiences, sectionally, an increase of the liquidus temperature, which, depending on the selected soldering temperature, effects that regions of the bounding layer become isothermally viscous or solidify. In any case, however, the structure of the core volume scarcely changes.

As an example of application of this procedure, the components of a pressure measuring cell are joined. FIG. 2 shows the arrangement before the joining. The pressure measuring cell includes a ceramic platform 1 and a measuring membrane 2. Each of these is composed of aluminum oxide. The measuring membrane 2 and the platform are to be joined by means of an active hard solder, or braze, wherein the active hard solder, or braze, is provided as a annular solder preform 3 with a thickness of, for example, 20 μm, wherein on both end faces of the solder ring a bounding layer 4, 5 is deposited by sputtering-on a thickness of 1 μm to 2 μm.

The solder preform has the above described composition C_{K0} of the core volume, thus Zr and Ni in the stoichiometric ratio of, for instance, 3 to 1. The bounding layer has, in contrast, a composition C_{B0}, which lies near or at the eutectic point E.

By soldering in high vacuum at, for example, 850° C., the bounding layers 3, 4 react with the platform and with the measuring membrane 1, 2, so that a joint is formed, wherein the core volume of the active hard solder, or braze, does not melt and essentially retains its amorphous structure. The measuring membrane and the platform each bear an electrode 7, 6 of a capacitive transducer, wherein the electrodes can be prepared, for example, by depositing Ni.

1-20. (canceled)

21. An assembly, comprising:
a first ceramic body; and
a second ceramic body, wherein:
said first ceramic body and said second ceramic body are connected by means of a joint, said joint containing an active hard solder, or braze;
the active hard solder, or braze, has a continuous core volume, which is spaced from said first ceramic body and from said second ceramic body, in each case, by at least 1 μm, especially at least 2 μm;
said joint has a first bounding layer and a second bounding layer, which border on said first ceramic body, respectively said second ceramic body; and
said continuous core volume, which includes at least 50% of the volume of said joint is free of crystalline phases of size greater than 6 μm, especially greater than 4 μm, preferably greater than 2 μm.

22. An assembly, comprising:
a first ceramic body; and
a second ceramic body, wherein:
said first ceramic body and said second ceramic body are connected by means of a joint, said joint contains an active hard solder, or braze;
the active hard solder, or braze, averaged over a continuous core volume, which is spaced from said first ceramic body and from said second ceramic body, in each case, by at least 1 μm, especially at least 2 μm, has an average composition C_{K} having a liquidus temperature Tₗ(C_{K}),
wherein C_{K}:=(c_{K1}, . . . , c_{KN}), wherein |C_{K}|=1; and
the c_{Ki} are the stoichiometric fractions of the components Kᵢ i=1, . . . , N of the average composition of said active hard solder, or braze, in said core volume;
said joint has a first bounding layer and a second bounding layer, which border on said first ceramic body, respectively on said second ceramic body;
at least one of said bounding layers, which lies outside of said core volume, has an average composition C_{B} having a liquidus temperature Tₗ(C_{B}), which lies not less than 20 K, preferably not less than 40 K, and especially preferably not less than 80 K under the liquidus temperature Tₗ(C_{K}) of the average composition C_{K} of the core volume, wherein C_{B}:=(c_{B1}, . . . , c_{BN}), wherein |C_{B}|=1, and wherein the c_{Bi} are the stoichiometric fractions of the components Kᵢ i=1, . . . , N of the average composition of the active hard solder, or braze, in said bounding layer.

23. The assembly as claimed in claim 21, wherein:
at least one bounding layer has a thickness of no more than 3 μm, especially no more than 2 μm and preferably no more than 1 μm.

24. The assembly as a claimed in claim 21, wherein:
said joint is ring-shaped; and
said core volume is defined by a body of revolution, which is formed by rotation of a convex polygon, especially a rectangle, about the principal axis of revolution of said ring-shaped joint.

25. The assembly as claimed in claim 22, wherein:
said liquidus temperature rises from Tₗ(C_{B}) to the liquidus temperature Tₗ(C_{K}) monotonically with change of composition from C_{B} to C_{K}.

26. The assembly as claimed in claim 22, wherein:
the composition C_{B} has a liquidus temperature Tₗ(C_{B}), which lies no more than 300 K, especially no more than 150 K, and preferably no more than 50 K above the liquidus temperature Tₗ(Cₑ) of the eutectic point, respectively the nearest intersection with a eutectic valley having a composition Cₑ in the composition space; and
Cₑ:=(cₑ₁, . . . , c_{eN}), wherein |Cₑ|=1, and wherein the cₑᵢ are the stoichiometric fractions of the components Kᵢ with i=1, . . . , N at the eutectic point, respectively a nearest intersection with a eutectic valley.

27. The assembly as claimed in claim 22, wherein:
the alloy of said joint has at the eutectic point, respectively at the nearest intersection with a eutectic valley in the composition space, a composition Cₑ, wherein Cₑ:=(cₑ₁, . . . , c_{eN}), wherein |Cₑ|=1, wherein the cₑᵢ are the stoichiometric fractions of the components Kᵢ with i=1, . . . , N at the eutectic point, respectively at the nearest intersection with a eutectic valley;
the difference between the composition Cₑ and the composition C_{B} is describable with a normalized vector difference D_{eB}, wherein: Cₑ=C_{B}+a_{eB}*D_{eB}, with |D_{eB}|=1;
the difference between the composition C_{K} and the composition C_{B} is describable with a normalized vector difference D_{KB}, wherein: C_{K}=C_{B}+a_{KB}*D_{KB}, with |D_{KB}|=1, wherein a_{eB} and a_{KB} are positive scalars, and for the scalar product s_{eK}:=D_{eB}·D_{KB}:
s_{eK}<0, especially s_{eK}<−0.5, preferably s_{eK}<−0.8.

28. The assembly as claimed in claim 22, wherein:
the composition C_{K} of the core volume contains metals, which also the composition C_{B} of the bounding layer contains.

29. The assembly as claimed in claim 21, wherein:
said first ceramic body and/or said second ceramic body comprise/comprises Al₂O₃.

30. The assembly as claimed in claim 22, wherein:
said active hard solder, or braze, comprises Zr, Ni and Ti.

31. The assembly as claimed in claim 30, wherein:
the composition C_{K} contains essentially zirconium and nickel, for example, in a stoichiometric ratio of, for instance, 3 to 1; and
the zirconium fraction amounts to, for example, 76 atom-% and the nickel fraction, for example, 24 atom-%.

32. The assembly as claimed in claim 22, wherein:
the bounding layer has a composition C_{B}, which comprises, for instance, 42 to 52 atom-% Zr, 23 to 28 atom-% Ni and 24 to 30 atom-% Ti;
in given cases, Al diffuses in; and
in cases where Al is present, especially the titanium fraction is reduced.

33. The assembly as claimed in claim 21, wherein:
said two bounding layers of the joint have the composition C_{B}.

34. A pressure measuring cell, comprising:
an assembly including a first ceramic body; and a second ceramic body, wherein: said first ceramic body and said second ceramic body are connected by means of a joint, said joint containing an active hard solder, or braze; the active hard solder, or braze, has a continuous core volume, which is spaced from said first ceramic body and from said second ceramic body, in each case, by at least 1 μm, especially at least 2 μm; said joint has a first bounding layer and a second bounding layer, which border on said first ceramic body, respectively said second ceramic body; and said continuous core volume, which includes at least 50% of the volume of said joint is free of crystalline phases of size greater than 6 μm, especially greater than 4 μm, preferably greater than 2 μm, wherein:
said first ceramic body is a membrane body of a measuring membrane of the pressure measuring cell;
said second ceramic body is a platform of the pressure measuring cell; and
said platform and said measuring membrane are joined pressure-tightly with one another by means of said joint, which is ring-shaped.

35. A method for manufacturing an assembly, comprises a
first ceramic body and a second ceramic body, wherein the first ceramic body and the second ceramic body are to be connected by means of an active hard solder, or braze, the method comprises the steps of:
providing the active hard solder, or braze, between the ceramic bodies;
the active hard solder, or braze, has, averaged over a continuous core volume, an average composition C_{K0} having a liquidus temperature Tₗ(C_{K0}), wherein C_{K0}:=(c_{K01}, . . . , c_{K0N}), wherein |C_{K0}|=1, and wherein the c_{Ki} are the stoichiometric fractions of the components Kᵢ i=1, . . . , N of the average composition of the active hard solder, or braze, in the core volume;
the active hard solder, or braze, has, on at least one of its surfaces facing the ceramic bodies, a bounding layer having an average composition C_{B0}, wherein the composition C_{B0} has a liquidus temperature Tₗ(C_{B0}), which lies not less than 20 K, preferably not less than 40 K, and especially preferably not less than 80 K, under the liquidus temperature Tₗ(C_{H0}) of the average composition C_{K0} of the main volume, wherein C_{B0}:=(c_{B01}, . . . , c_{B0N}), wherein |C_{B0}|=1, and wherein the c_{B0i} are the stoichiometric fractions of the components Kᵢ i=1, . . . , N of the average composition of the active hard solder, or braze, in the bounding layer; and
heating the ceramic bodies and the active hard solder, or braze, in a vacuum soldering, brazing process up to melting of the composition C_{B0}, wherein the melt of the bounding layer mixes in the transition to the core volume with the material of the core volume, whereby the liquidus temperature of the bounding layer is increased, so that the bounding layer at least partially isothermally solidifies or becomes more viscous.

36. The method as claimed in claim 35, wherein:
the providing of the active hard solder, or braze, includes a solder preform, which has the composition C_{K0}, coated by means of gas phase deposition, for example, by sputtering, at least on one surface, preferably on two oppositely lying surfaces, with a bounding layer, which has the composition C_{B0}.

37. The method as claimed in claim 35, wherein:
the providing of the active hard solder, or braze, includes at least one surface section of a ceramic body, especially two oppositely lying surface sections of the two ceramic bodies, respectively, coated with a bounding layer, which has the composition C_{B0}, and
the coating occurs, for example, by gas phase deposition, especially sputtering.

38. The method as a claimed in claim 37, wherein:
there is arranged between the ceramic bodies provided with the bounding layer a solder preform, which has a core volume with the composition C_{K0}, and which, in given cases, is coated with a bounding layer of composition C_{B0}.

39. The method as claimed in claim 35, wherein:
a composition K_{K0} comprises Zr and Ni in a stoichiometric ratio of 3 to 1, for example, 20 atom-% to 30 atom-% Ni and remainder Zr, especially, for instance, 22 atom-% to 26 atom-% Ni, preferably 24 atom-% Ni.

40. The method as claimed in claim 35, wherein:
the composition C_{B0} comprises, for instance, 42 to 52 atom-% Zr, 23 to 28 atom-% Ni and 24 to 30 atom-% Ti, for example, 45 to 49 atom-% Zr, 24.5 to 27 atom-% Ni and 26 to 29.5 atom-% Ti, and preferably 47 atom-% Zr, 26 atom-% Ni and 27 atom-% Ti.
